(19) United States
(12) Patent Application Publication
(10) Pub. No.: US 2011/0179717 A1
(43) Pub. Date: Jul. 28, 2011

(54) SUBSTRATE PROCESSING APPARATUS

(75) Inventor: Tomoshi Taniyama, Toyama (JP)

(73) Assignee: HITACHI KOKUSAI ELECTRIC INC., Tokyo (JP)

(21) Appl. No.: 13/010,096

(22) Filed: Jan. 20, 2011

(30) Foreign Application Priority Data
Jan. 27, 2010 (JP) 2010-015388
Jun. 23, 2010 (JP) 2010-142886

(51) Int. Cl. E05F 1/00

(52) U.S. Cl. 49/324

(57) ABSTRACT

Provided is a substrate processing apparatus comprising a closing assistance mechanism in which bending of a seal cap and a furnace port shutter arm is corrected, an O-ring is sufficiently pressed, and a process chamber is sufficiently sealed. The substrate processing apparatus comprises: a process chamber comprising an opening for loading a substrate therethrough, the process chamber performing a processing operation on the substrate loaded therein; a first cover configured to close the opening of the process chamber when a substrate is loaded in the process chamber; a first opening/closing mechanism configured to open/close the first cover; a second cover configured to close the opening of the process chamber when no substrate is loaded in the process chamber; a second opening/closing mechanism configured to open/close the second cover; and a closing assistance mechanism configured to assist the first and the second opening/closing mechanisms.

### CROSS-REFERENCE TO RELATED PATENT APPLICATION

This U.S. non-provisional patent application claims priority under 35 U.S.C. §119 of Japanese Patent Application Nos. 2010-015388, filed on Jan. 27, 2010, and 2010-142886, filed on Jun. 23, 2010, in the Japanese Patent Office, the entire contents of which are hereby incorporated by reference.

### BACKGROUND OF THE INVENTION

1. Field of the Invention

The present invention relates to substrate processing technology, for example, a method of sealing a process chamber of a substrate processing apparatus that is an apparatus of manufacturing a semiconductor integrated circuit device (hereinafter, referred to as an IC), particularly, a method of sealing a process chamber of a vertical batch type heat treatment apparatus. In the vertical batch type heat treatment apparatus, for forming a desired film on a semiconductor substrate (e.g., a semiconductor wafer) on which an IC is formed, heat treating such as chemical vapor deposition (CVD) is performed.

2. Description of the Related Art

For example, in a vertical batch type heat treatment apparatus, a boat holding a plurality of wafers is mounted on a seal cap having a disk shape, the boat is loaded into a process chamber from an opening defined in a lower side of a process chamber having an approximately cylindrical shape, the opening defined in the lower side of the process chamber is closed by the seal cap, and the process chamber is sealed to perform a heat treating process on the plurality of wafers at the same time. After the heat treating process, the boat holding the plurality of wafers is unloaded through the opening defined in the lower side of the process chamber, thereafter, the opening defined in the lower side of the process chamber is closed by a furnace port shutter having a disk shape, and the process chamber is sealed. Since the opening of the process chamber is closed after the heat treating process, high-temperature atmosphere in the process chamber is prevented from flowing to the outside of the process chamber, and ambient atmosphere is not sucked into the process chamber.

A conventional sealing structure will be described with reference to FIG. 6. FIG. 6A is a vertical sectional view illustrating the sealing structure for the case of sealing a process chamber using a seal cap after a boat is loaded into a process chamber. FIG. 6B is a vertical sectional view illustrating the sealing structure for the case of sealing the process chamber using a furnace port shutter after heat treating is ended and the boat is unloaded from the process chamber.

In FIG. 6A, a seal cap 219 having a disk shape is installed on a seal cap base 62 with a spring 63 being disposed therebetween, and the seal cap base 62 is fixed to a seal cap arm 61 having an approximately rectangular parallelepiped shape. The seal cap arm 61 may be vertically moved by a boat elevator 121, and thus, the seal cap 219 may vertically moved also. A boat 217 holding a plurality of wafers is mounted on the seal cap 219 to elevate the boat 217, and the boat 217 is loaded into the process chamber 201 from an opening defined in a lower side of the process chamber 201. Thereafter, the seal cap 219 is elevated to push the seal cap 219 toward a bottom side of the process chamber 201 using a spring force of the spring 63. Thus, an O-ring 220 is compressed to seal the process chamber 201.

Particularly, if each of the wafers is reduced to a diameter of 450 mm and the boat 217 holding the wafer is increased in weight, the seal cap arm 61 is bent to sufficiently compress the O-ring 220 disposed on a side opposite to that of the seal cap arm 61 as shown in FIG. 6A. Thus, the process chamber may not be sufficiently sealed.

Also, in FIG. 6B, a furnace port shutter 116 having a disk shape is installed on a furnace port shutter base 66 with a spring 67 such as a coil spring being disposed therebetween, and the furnace port shutter base 66 is fixed to a furnace port shutter arm 65 having an approximately rectangular parallelepiped shape. The furnace port shutter arm 65 is horizontally rotated up to a lower side of the process chamber 201, and then is vertically movable. Thus, the furnace port shutter 116 is vertically movable also. As shown in FIG. 6B, after the heat treating is ended, the boat 217 is unloaded from the process chamber 201, and the furnace port shutter 116 is horizontally rotated up to a lower side of the process chamber 201 and ascends. By being pressed toward the bottom side of the process chamber 201 using a spring force of the spring 67, the O-ring is compressed and pressed to seal the process chamber 201. In this case, if the furnace port shutter arm 65 is bent, the compression of the O-ring disposed on a side opposite to that of the furnace port shutter arm 65 is insufficient, and thus, the process chamber 201 may not be sufficiently sealed.

In the following patent document 1, a closing assistance device for assisting a closing force when a furnace port shutter closes an opening defined in a bottom side of a process chamber is disclosed. In the closing assistance device of the patent document 1, at a lower side of a front end part of a shutter holding arm supporting the furnace port shutter, a horizontally protrudable cylinder is installed, and the cylinder is engaged with a cylinder support block fixedly installed on a case to perform the closing assistance. Thus, particles may be generated by a friction between the cylinder and the cylinder support block. Also, since the closing assistance device is installed on the furnace port shutter, the furnace port shutter may increase in weight. Also, since the closing assistance device is disposed near to the process chamber, the closing assistance device may be exposed to a high temperature.

[Patent Document 1] Japanese Unexamined Patent Application Publication No. 2007-73746

### SUMMARY OF THE INVENTION

An object of the present invention is to provide a substrate processing apparatus, which solves related-art problems in which, when a substrate is placed inside and outside a process chamber, for example, an O-ring disposed between a cover such as a seal cap or a furnace port shutter and an opening end of the process chamber is not sufficiently pressed, and thus, the process chamber is not sufficiently sealed, and includes a seal support (closing assistance) mechanism configured to sufficient seal a process chamber when a substrate is placed inside and outside the process chamber.

According to an aspect of the present invention, there is provided a substrate processing apparatus comprising: a process chamber comprising an opening for loading a substrate therethrough, the process chamber performing a processing operation on the substrate loaded therein; a first cover configured to close the opening of the process chamber when a substrate is loaded in the process chamber; a first opening/closing mechanism configured to open/close the first cover; a second cover configured to close the opening of the process chamber when no substrate is loaded in the process chamber; a second opening/closing mechanism configured to open/close the second cover; and a closing assistance mechanism configured to assist the first and the second opening/closing mechanisms.

### BRIEF DESCRIPTION OF THE DRAWINGS

FIG. 1 is a perspective view illustrating a vertical batch type heat treatment apparatus according to an embodiment of the present invention.

FIG. 2 is a vertical sectional view illustrating a process furnace of the vertical batch type heat treatment apparatus according to the embodiment of the present invention.

FIG. 3 is a view for explaining a sealing operation by a seal cap according to the embodiment of the present invention.

FIG. 4 is a view for explaining a sealing operation by a furnace port shutter according to the embodiment of the present invention.

FIG. 5 is a view for explaining an operation of a closing assistance mechanism according to the embodiment of the present invention.

FIG. 6 is a view for explaining a sealing operation by a seal cap and a furnace port shutter according to a related art.

FIG. 7 is a view illustrating an airflow within a case according to the embodiment of the present invention.

FIG. 8 is a view for explaining a modified example of a case in which cooling gas is exhausted from a seal support arm according to the embodiment of the present invention.

### DETAILED DESCRIPTION OF THE PREFERRED EMBODIMENTS

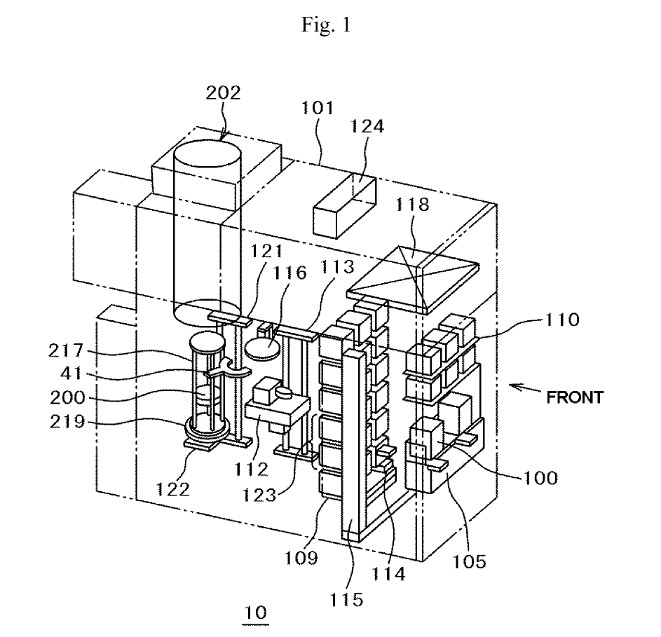

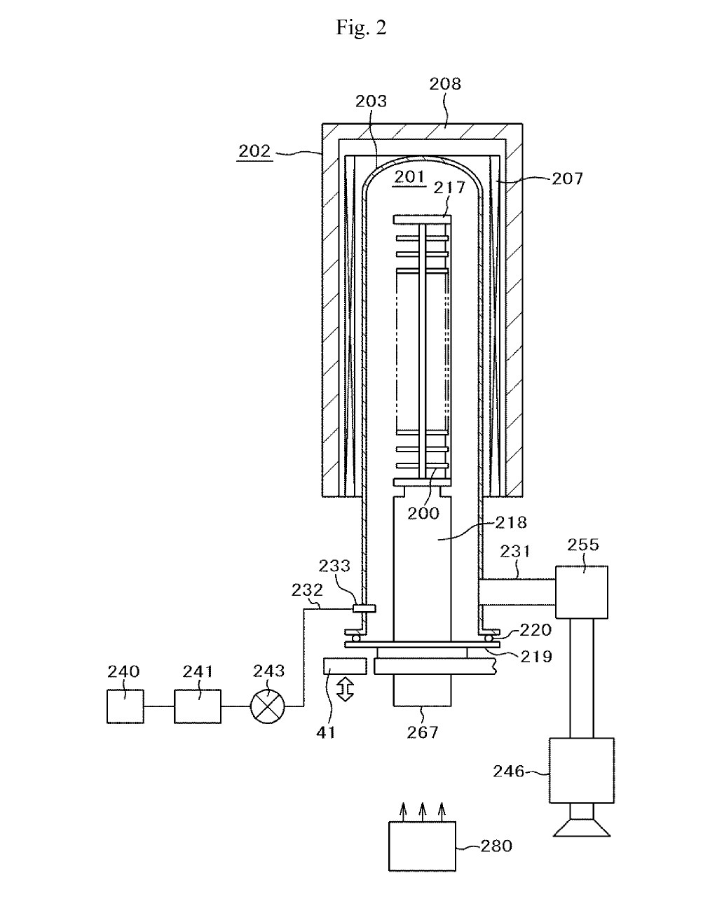

In an embodiment, a substrate processing apparatus is, as one example, configured as a semiconductor manufacturing apparatus, which performs a processing operation in a method of manufacturing an IC. Hereinafter, an embodiment of the present invention will be described with reference to the attached drawings. FIG. 1 is a perspective view illustrating a vertical batch type heat treatment apparatus according to an embodiment of the present invention. FIG. 2 is a vertical sectional view illustrating a process furnace of the vertical batch type heat treatment apparatus according to the embodiment of the present invention.

[Overview of Substrate Processing Apparatus]

First, with reference to FIG. 1, and FIG. 2, a substrate processing apparatus 10 according to an embodiment of the present invention will be schematically described. As shown in FIG. 1, at a front inner side of a case 101 of the substrate processing apparatus 10, a cassette stage 105 is installed. Between the cassette stage 105 and an external carrying device (not shown), cassettes 100 which are substrate containers are transferred. At the backside of the cassette stage 105, a cassette carrying machine 115 is installed. At the backside of the cassette carrying machine 115, a cassette shelf 109 is installed to store cassettes 100. In addition, at the upper side of the cassette stage 105, a standby cassette shelf 110 is installed to store cassettes 100. At the upper side of the standby cassette shelf 110, a cleaning unit 118 is installed. The cleaning unit 118 is provided to circulate clean air in the case 101.

At the rear upper side of the case 101, a process furnace 202 having an approximately cylindrical shape is installed. At the lower side of the process furnace 202, a boat elevator 121 is installed. The boat elevator 121 raises a boat 217 in which wafers 200 are held to the inside of the process furnace 202 and lowers the boat 217 from the inside of the boat 217. The boat 217 is a substrate holding tool configured to hold wafers 200 horizontally in multiple stages. At the boat elevator 121, a seal cap 219 having an approximately disk shape is installed as a cover configured to close the bottom side of the process furnace 202. The seal cap 219 supports the boat 217 vertically.

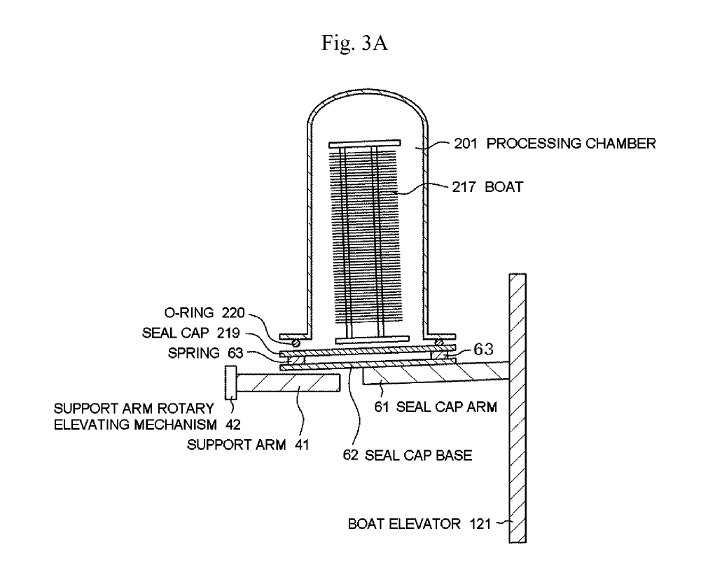

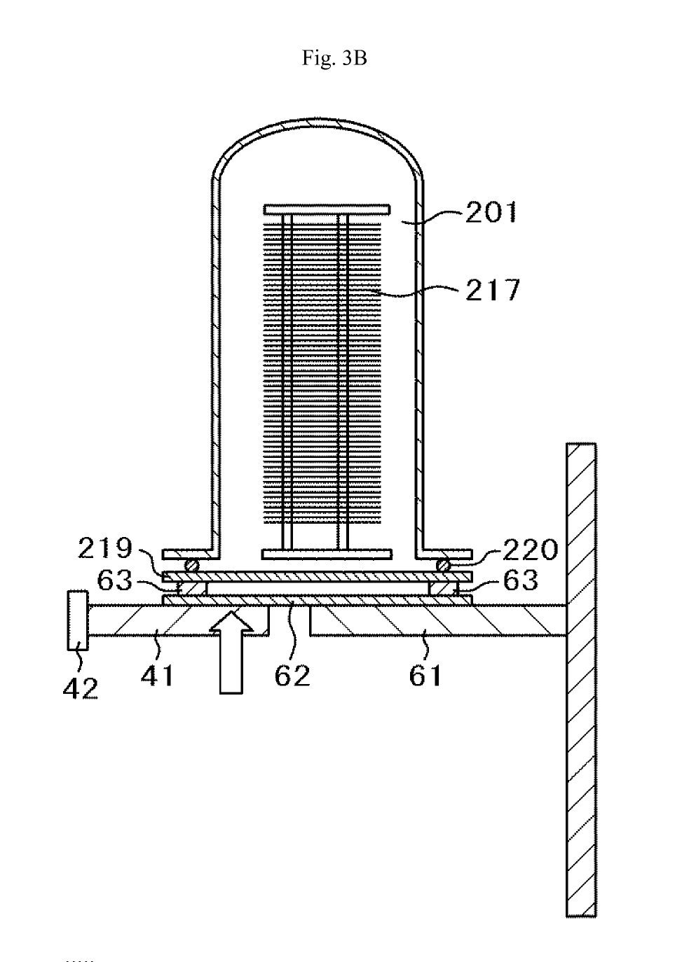

Between the boat elevator 121 and the cassette shelf 109, the wafer transfer machine 112 is installed to carry wafers 200. At a side of the boat elevator 121, a furnace port shutter 116 having an approximately disk shape is installed as a cover configured to airtightly close the bottom side of the process furnace 202. The furnace port shutter 116 may close the bottom side of the process furnace 202 when the boat 217 is disposed outside the process furnace 202. At a position near to the furnace port shutter 116 and the boat elevator 121, a seal support arm 41 is installed to assist the closing operation when the seal cap 219 and the furnace port shutter 116 close the bottom side of the process furnace 202. The seal support arm 41 may be horizontally rotatable or vertically movable by a support arm rotary elevating mechanism 42 (refer FIG. 3).

Cassettes 100 in which wafers 200 are charged are carried to the cassette stage 105 by the external carrying device (not shown). In addition, the cassettes 100 are carried from the cassette stage 105 to the cassette shelf 109 or the standby cassette shelf 110 by the cassette carrying machine 115. At the cassette shelf 109, a transfer shelf 123 is provided to store cassettes 100 which are carrying objects of the wafer transfer machine 112. Cassettes 100 are transferred to the transfer shelf 123 by the cassette carrying machine 115 so as to transfer wafers 200 from the cassettes 100 to the boat 217. After the cassettes 100 are transferred to the transfer shelf 123, wafers 200 are transferred by the wafer transfer machine 112 from the cassettes 100 of the transfer shelf 123 to the boat 217 in a state where the boat 217 is moved downward.

After a predetermined number of wafers 200 are transferred into the boat 217, the boat 217 is loaded into the process furnace 202 by the boat elevator 121, and the process furnace 202 is hermetically closed by the seal cap 219. At this time, after the seal support arm 41 assisting the closing force to the seal cap 219 is directly rotated and moved by the support arm rotary elevating mechanism 42 (refer FIG. 3), the seal support arm 41 is elevated to compress the seal cap 210 from a lower side and assist the closing operation of the process furnace 202. Within the hermetically sealed process furnace 202, the wafers 200 are heated, and simultaneously, process gas is supplied into the process furnace 202 to perform a process such as a heating process onto the wafers 200.

After the wafers 200 are processed, in the reverse order to the order of the above-described operations, the wafers 200 are transferred from the boat 217 to the cassettes 100 of the transfer shelf 123 by the wafer transfer machine 112, and the cassettes 100 are transferred from the transfer shelf 123 to the cassette stage 105 by the cassette carrying machine 115. Then, the cassettes 100 are carried to the outside of the case 101 by the external carrying device (not shown).

When the boat 217 is moved downward, the furnace port shutter 116 closes the bottom side of the process furnace 202 hermetically so that outside air cannot enter the process furnace 202. At this time, after the seal support arm 41 assisting the closing force to the furnace port shutter 116 is directly rotated and moved by the support arm rotary elevating mechanism 42 (refer to FIG. 3), the seal support arm 41 is elevated to compress the seal cap 210 from the lower side and assist the closing operation of the process furnace 202.

[Process Furnace]

As shown in FIG. 1 and FIG. 2, according to the current embodiment, the substrate processing apparatus 10 includes the process furnace 202, and the process furnace 202 includes a reaction tube 203 having an approximately cylindrical shape and made of quartz. The reaction tube 203 is a reaction vessel configured to accommodate substrates (in the current embodiment, wafers 200) and process the substrates.

The reaction tube 203 is installed in a heating unit (in the current embodiment, a resistance heater) 207. A bottom opening of the reaction tube 203 can be hermetically closed by the seal cap 219 in a state where a sealing member (in the current embodiment, O-ring 220) is disposed between the reaction tube 203 and the seal cap 219.

The heater 207, the reaction tube 203, and the seal cap 219 constitute the process furnace 202. In addition, the reaction tube 203 and the seal cap 219 constitute a process chamber 201. On the seal cap 219, the substrate holding tool (boat 217) is erected with a quartz cap 218 being disposed therebetween. The quartz cap 218 is a holder holding the boat 217. The boat 217 is configured to be inserted into the process furnace 202 through a bottom opening of the process furnace 202. In the boat 217, a plurality of wafers 200 to be batch-processed are horizontally held and piled in multiple stages in the axial direction (vertical direction) of the boat 217. The heater 207 is used to heat the wafers 200 inserted in the process furnace 202 at a predetermined temperature.

[Gas Supply System]

As shown in FIG. 2, according to the current embodiment, a plurality of kinds, however herein, one kind of process gas is supplied into the process chamber 201. In a process gas supply tube 232, in order from upstream, the process gas supply source 240, a mass flow controller 241 used as a flowrate control unit, and a valve 243 used as an on/off device are installed. The process gas as a source gas is supplied from the process gas supply source 240 into the process chamber 201 in a state where the mass flow controller 241, the valve 243, and a nozzle 233 are disposed therebetween.

[Boat]

At the center part in the reaction tube 203, the boat 217 in which the plurality of wafers 200 are placed in multiple stages at the same interval is installed, and the boat 217 is configured to be moved into and out of the reaction tube 203 by the boat elevator 121 (refer to FIG. 1). Also, for improving processing uniformity, a boat rotating mechanism 267 that is a rotation device (rotation unit) for rotating the boat 217 is installed, and the boat 217 held to the quartz cap 218 is rotated by the boat rotating mechanism 267.

[Exhaust Unit]

An end of an exhaust pipe 231 is connected to the process chamber 201 to exhaust gas from the inside of the process chamber 201. The other end of the exhaust pipe 231 is connected to a vacuum pump (exhaust device) 246 with an auto pressure controller (APC) valve being disposed therebetween. The inside of the process chamber 201 is vacuum-evacuated by the vacuum pump 246.

Also, the APC valve 255 is an on/off valve, which can perform exhaust and stop of exhaust within the process chamber 201 by an opening/closing operation of the valve, and also, the APC valve 255 is a pressure regulating valve, which can regulate a pressure by adjusting a degree of valve opening.

[Control Unit]

A controller 280 (control unit) is electrically connected to each of the components of the substrate processing apparatus 10 such as the mass flow controller 241, the valve 243, the APC valve 255, the heater 207, the vacuum pump 246, the boat rotating mechanism 267 and boat elevator 121.

The controller 280 controls operations of the components of the substrate processing apparatus 10, such as a flowrate adjusting operation of the mass flow controller 241, the opening/closing operation of the valve 243, the on/off operation and a pressure regulating operation of the APC valve 255, a temperature adjusting operation of the heater 207, driving and stopping operations of the vacuum pump 246, a rotation speed adjustment operation of the boat rotating mechanism 267, and an elevating operation of the boat elevator 121.

In the substrate processing apparatus 10 including the above-described components, on the wafers 200 loaded on the boat 217, the heat treating process that is one of the processes of manufacturing the semiconductor device is performed.

[Operation of Sealing Process Furnace by Seal Cap]

Next, an operation of sealing the process furnace 202 by the seal cap 219 will be described in detail with reference to FIG. 3. FIG. 3 is a view for explaining a sealing operation by the seal cap 219 according to the embodiment of the present invention. In FIG. 3, a seal cap arm 61 having an approximately rectangular parallelepiped shape is a movable member extending in a horizontal direction to move the seal cap 219 having the approximately disk shape. One end of the seal cap arm 61 may be installed movable in a vertical direction with respect to the boat elevator 121, and the other end may be fixedly installed on the seal cap base 62. The seal cap base 62 and the seal cap 219 are coupled by a plurality of springs 63. The springs 63 are constituted by coil springs expandable and contractible in a vertical direction. At a bottom side of the process chamber 201, the O-ring 220 having a circular shape in section is installed. One end of the seal support arm 41 is installed on the support arm rotary elevating mechanism 42 rotatably and elevatably.

In the current embodiment, the seal cap 219, the springs 63, and the seal cap base 62 constitute a first cover, and the boat elevator 121 and the seal cap arm 61 constitute a first opening/closing mechanism. In addition, the seal cap arm 61 constitutes a first movable member, and the seal support arm 41 and the support arm rotary elevating mechanism 42 constitute a first closing assistance mechanism. Also, the boat elevator 121 constitutes a first vertical movement mechanism (elevating mechanism). The seal support arm 41 elevates to an approximate height of the first cover, and the seal support arm 41 is a pressing unit, which applies an upward power to the first cover. The support arm rotary elevating mechanism 42 assists the closing force of the first opening/closing mechanism by the ascending operation thereof, and also is rotated in a horizontal direction.

An operation of sealing the inside of the process chamber 201 by the seal cap 219 will be described below. As the seal cap arm 61 is elevated by the boat elevator 121, the seal cap base 62 ascends, and thus, by the springs 63 being disposed therebetween, the seal cap 219 is elevated to close a bottom side of the process chamber 201. Also, while the seal cap arm 61 ascends, by the support arm rotary elevating mechanism 42, the seal support arm 41 is rotated in a horizontal direction with respect to a direct under (assistance operation position) of the seal cap 219. Then, the seal support arm 41 ascends to compress the bottom side of the process chamber 201 by a spring force of each of the springs 63. Thus, as shown in FIG. 3B, the O-ring 220 may be deformably pressed over the entire circumference thereof to airtightly seal (close) the inside of the process chamber 201.

FIG. 3A illustrates a state in which the seal cap 219 is compressed into the bottom side of the process chamber 201 by only the seal cap arm 61. By a weight of the wafer placed on the seal cap 219 or the boat, the seal cap arm 61 is bent and the seal cap 219 is inclined. As a result, the O-ring 220 is not sufficiently pressed over the entire circumference thereof and does not sufficiently seal the inside of the process chamber 201. In FIG. 3A, although the O-ring 220 disposed at a side of the seal cap arm 61 is pressed, the O-ring 220 disposed on a side opposite to that of the seal cap arm 61 is not pressed.

FIG. 3B illustrates a state in which the seal cap 219 is compressed into the bottom side of the process chamber 210 by both the seal cap arm 61 and the seal support arm 41. By the seal support arm 41, the bending of the seal cap arm 61 is compensated to maintain horizontality of the seal cap 219. As a result, the O-ring may be pressed over the entire circumference thereof to sufficiently seal the inside of the process chamber 201.

[Operation of Sealing Process Furnace by Furnace Port Shutter]

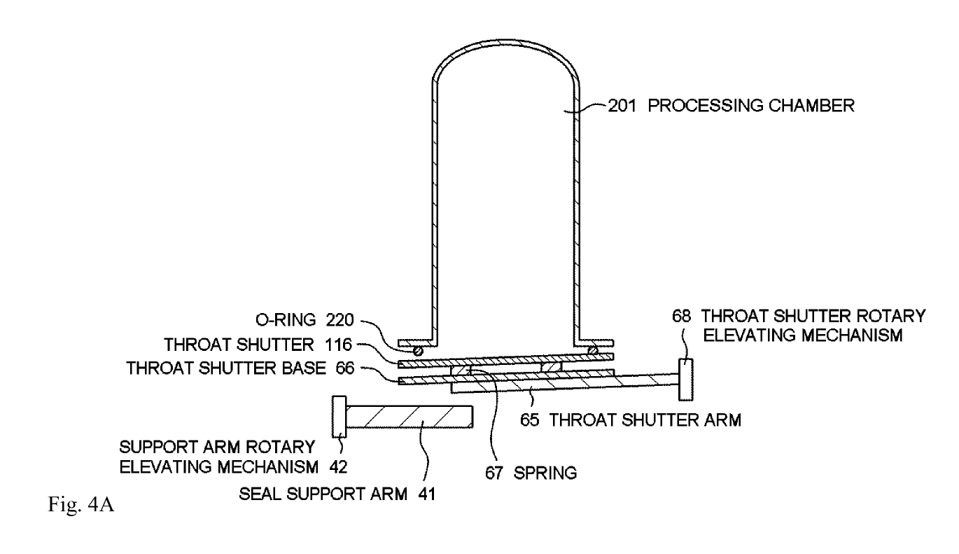

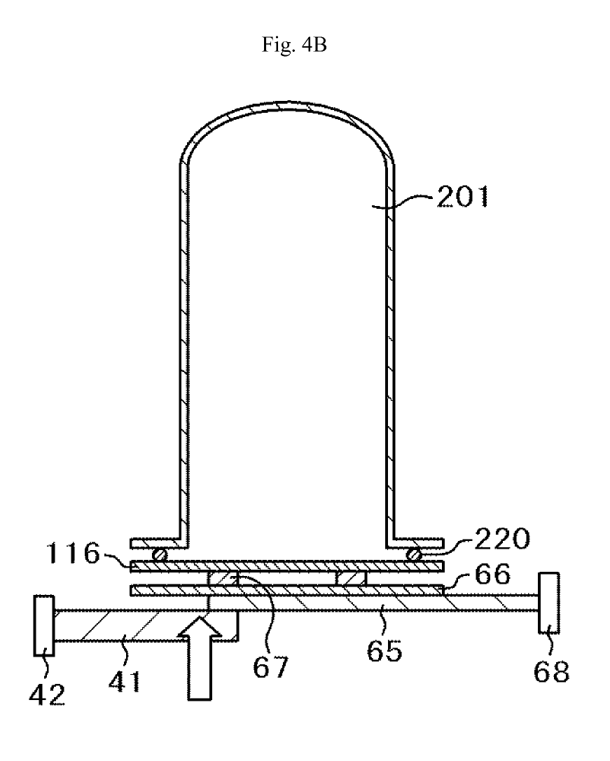

Next, an operation of sealing the process furnace 202 by the furnace port shutter 116 will be described in detail with reference to FIG. 4. FIG. 4 is a view for explaining a sealing operation by the furnace port shutter 116 according to the embodiment of the present invention. In FIG. 4, a furnace port shutter arm 65 having an approximately rectangular parallelepiped shape is a movable member extending in a horizontal direction to move the furnace port shutter 116 having the approximately disk shape. One end of the furnace port shutter arm 65 is installed movable in a vertical direction with respect to a furnace port shutter rotary elevating mechanism 68, and the other end is fixedly installed on a furnace port shutter base 66. The furnace port shutter base 66 and the furnace port shutter 116 are coupled by a plurality of springs 67. The springs 67 are constituted by coil springs expandable and contractible in a vertical direction. At the bottom side of the process chamber 201, the O-ring 220 having a circular shape in section is installed. One end of the seal support arm 41 is installed on the support arm rotary elevating mechanism 42 rotatably and elevatably.

In the current embodiment, the furnace port shutter 116, the springs 67, the furnace port shutter base 66 constitute a second cover, and the furnace port shutter rotary elevating mechanism 68 and the furnace port shutter arm 65 constitute a second opening/closing mechanism. In addition, the furnace port shutter arm 65 constitutes a second movable member, and the seal support arm 41 and the support arm rotary elevating mechanism 42 constitute a second closing assistance mechanism. Also, the furnace port shutter rotary elevating mechanism constitutes a second vertical movement mechanism (elevating mechanism). The seal support arm 41 elevates to an approximate height of the second cover, and the seal support arm 41 is a pressing unit, which applies an upward power to the second cover. The support arm rotary elevating mechanism 42 assists the closing force of the second opening/closing mechanism by the ascending operation thereof, and also is rotated in a horizontal direction.

As described above, in the current embodiment, the first closing assistance mechanism and the second closing assistance mechanism communize the same mechanism.

An operation of sealing the inside of the process chamber 201 by the furnace port shutter 116 will be described below.

By the furnace port shutter rotary elevating mechanism 68, the furnace port shutter arm 65 is horizontally rotated up to a direct under of the process chamber 201 and ascends. As a result, the furnace port shutter base 66 ascends, and thus, by the springs 67 being disposed therebetween, the furnace port shutter 116 ascends to close the bottom side of the process chamber 201.

Also, while the furnace port shutter arm 65 ascends, by the support arm rotary elevating mechanism 42, the seal support arm 41 is rotated up to a direct under of the furnace port shutter 116. Then, the seal support arm 41 ascends to compress the bottom side of the process chamber 201 by a spring force of each of the springs 67. As a result, as shown in FIG. 4B, the O-ring 220 may be deformably pressed over the entire circumference thereof to airtightly seal (close) the inside of the process chamber 201.

FIG. 4A illustrates a state in which the furnace port shutter 116 is compressed into the bottom side of the process chamber 201 by only the furnace port shutter arm 65. By a pressure of the process chamber 201, the furnace port shutter arm 65 is bent and the furnace port shutter 116 is inclined. As a result, the O-ring 220 is not sufficiently pressed over the entire circumference thereof and does not sufficiently seal the inside of the process chamber 201. In FIG. 4A, although the O-ring 220 disposed at a side of the furnace port shutter arm 65 is pressed, the O-ring 220 disposed on a side opposite to that of the furnace port shutter arm 65 is not pressed.

FIG. 4B illustrates a state in which the furnace port shutter 116 is compressed into the bottom side of the process chamber 210 by both the furnace port shutter arm 65 and the seal support arm 41. By the seal support arm 41, the bending of the furnace port shutter arm 65 is compensated to maintain horizontality of the furnace port shutter 116. As a result, the O-ring may be pressed over the entire circumference thereof to sufficiently seal the inside of the process chamber 201. Also, as shown in FIG. 4B, the seal support arm 41 may apply an upward force to the furnace port shutter arm 65, or the seal support arm 41 may directly apply an upward force to the furnace port shutter base 66.

[Operation Description of Closing Assistance Mechanism]

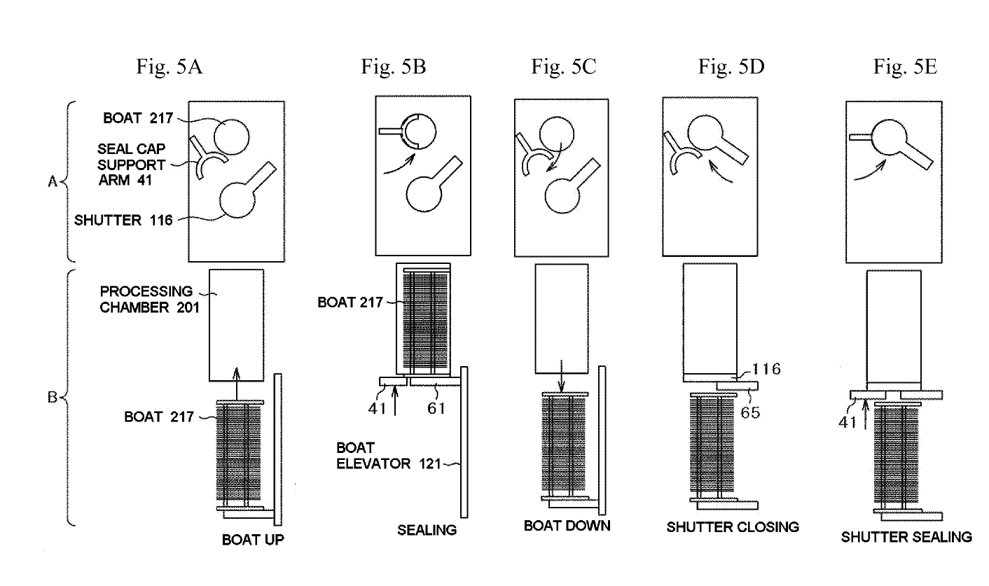

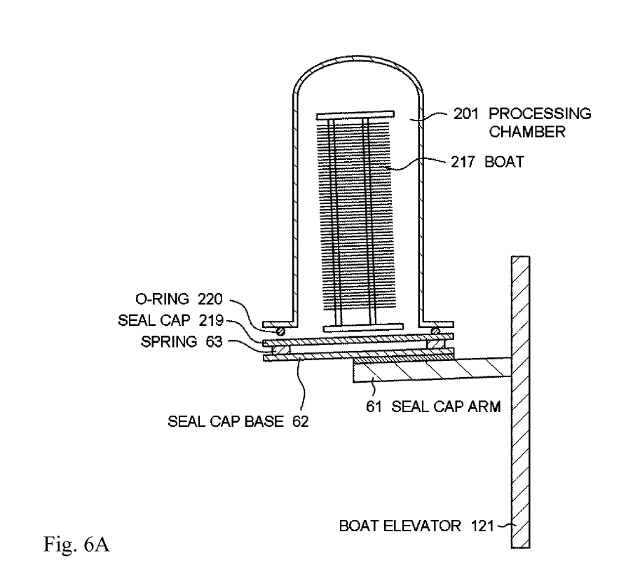

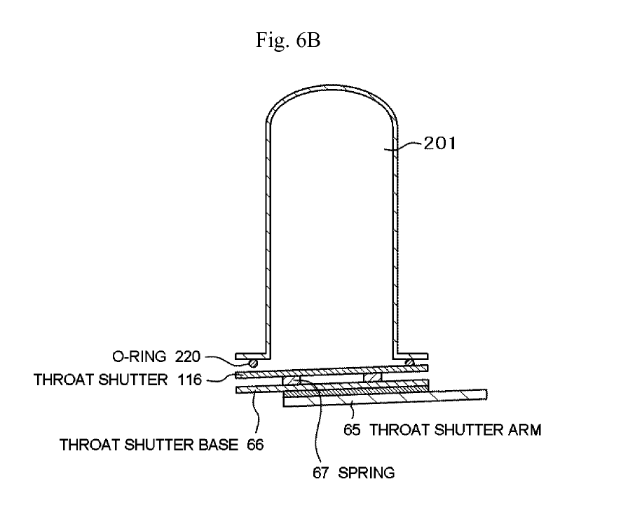

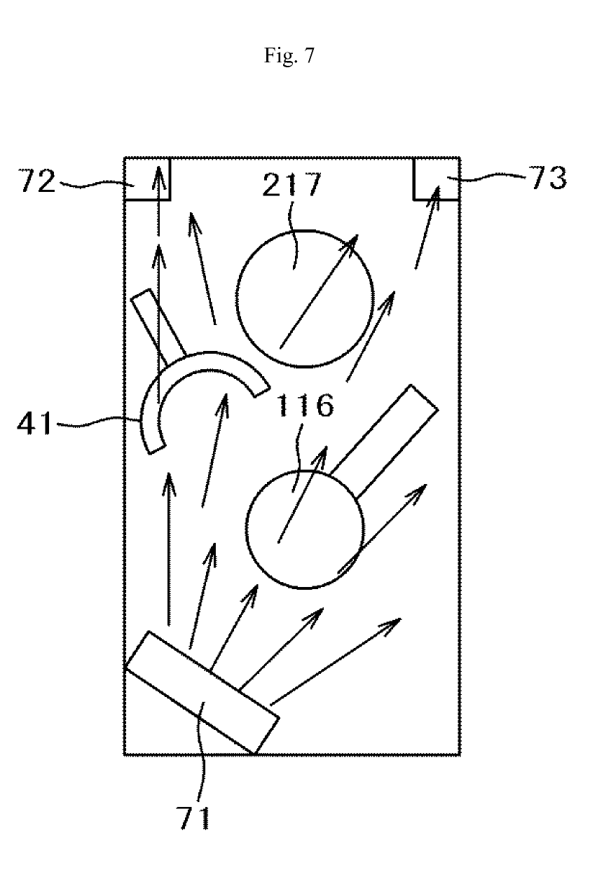

Next, an operation of the closing assistance mechanism will be described with reference to FIG. 5. FIG. 5 is a view for explaining an operation of a closing assistance mechanism according to the embodiment of the present invention. In FIG. 5, a section A of an upper half part illustrates a plan view of the substrate processing apparatus 10 when viewed from an upper side, and a section B of a lower half part illustrates a view when viewed in a side. FIG. 5 is schematic view, and the seal cap 219 and the furnace port shutter base 66 are omitted.

FIG. 5A illustrates a state when the boat 217 is up, i.e., before the boat 217 is loaded into the process chamber 201. When the boat 217 is up, the seal support arm 41 and the furnace port shutter 116 are placed at standby positions, respectively. FIG. 5B illustrates a state when sealed by the seal cap 219, i.e., after the boat 217 is loaded into the process chamber 201. At this time, as the seal support arm 41 is rotated up to a sealing position, i.e., a position of the seal cap 219 and ascends, the seal cap 219 is supported together with the seal cap arm 61 and compressed into the bottom side of the process chamber 201. As described above, when the seal support arm 41 pushes up a position opposite to that of the boat elevator 121 of the seal cap 219, the O-ring 222 may be more uniformly pressed over the entire circumference to sufficiently seal the inside of the process chamber 201.

FIG. 5C illustrates a state when the boat 217 is down, i.e., before the furnace port shutter 116 is closable after the boat 217 is unloaded from the process chamber 201. At this time, before the boat down starts, the seal support art 41 is rotated to return to the standby position.

FIG. 5D illustrates a state when the furnace port shutter 116 is closed, i.e., before the sealing is assisted by the seal support arm 41 after the boat 217 is unloaded from the process chamber 201 and then the furnace port shutter 116 is closed. At this time, after the boat down is completed, the furnace port shutter 116 is rotated, and the O-ring is disposed therebetween to seal the process chamber 201. However, since only the furnace port shutter arm 65 supports the furnace port shutter 116, due to the bending of the furnace port shutter arm 65, sufficient sealing is impossible.

FIG. 5E illustrates a state when sealed by the furnace port shutter 116, i.e., after the furnace port shutter 116 is closed and the sealing is assisted by the seal support arm 41. At this time, as the seal support arm 41 is horizontally rotated up to a sealing position, i.e., a position of the furnace port shutter 116 and ascends, the furnace port shutter 116 is supported together with the furnace port shutter arm 65 and is compressed into the bottom side of the process chamber 201. Like this, when the seal support arm 41 pushes up a position opposite to that of the furnace port shutter rotary elevating mechanism 68, the O-ring 220 may be more uniformly pressed over the entire circumference to sufficiently seal the inside of the process chamber 201.

Like this, in the current embodiment, when sealed by the furnace port shutter 116 and when sealed by the seal cap 219, although the sealing is performed using the seal support arm 41 that is the same closing assistance mechanism, a separate closing assistance mechanism may be used. Also, the rotary elevating mechanism 42 of the seal support arm 41 and the rotary elevating mechanism 68 of the furnace port shutter 116 may have a common structure, and thus, components used for the rotary elevating mechanism 42 of the seal support arm 41 and the rotary elevating mechanism 68 of the furnace port shutter 116 may be communized. Also, in the current embodiment, although the closing assistance mechanism is configured to be rotatable and elevatable, like the furnace port shutter 116, the closing assistance mechanism may be configured to be elevatable, but rotatable, like the boat elevator 121.

FIG. 7 is a view illustrating an airflow within the case according to the embodiment of the present invention. In FIG. 7, an arrow represents an airflow.

As shown in FIG. 7, in the current embodiment, exhaust units 72 and 73 for exhausting air within the case to the outside of the case are installed on a backside edge part of the case. Also, between a clean unit 71 supplying clean air into the case and the one side exhaust unit 72, i.e., on a straight line connecting the clean unit 71 to the exhaust unit 72, the seal support arm 41 is disposed. Also, between the clean unit 71 and the other side exhaust unit 73, i.e., on a straight line connecting the clean unit 71 and the exhaust unit 73, the furnace port shutter 116 is disposed. Also, the boat is disposed so that a straight line connecting the clean unit 71 and the boat 217 is disposed between a straight line connecting the clean unit 71 and the seal support arm 41 and a straight line connecting the clean unit 71 and the furnace port shutter 116. Thus, at an upwind of the boat 217 on which the substrate is placed, the seal support arm 41 or the furnace port shutter 116, which is a mechanism part in which particles may be generated, is not disposed.

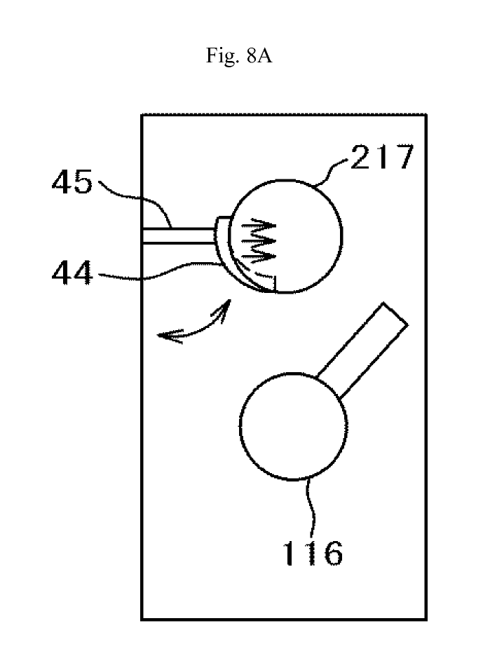

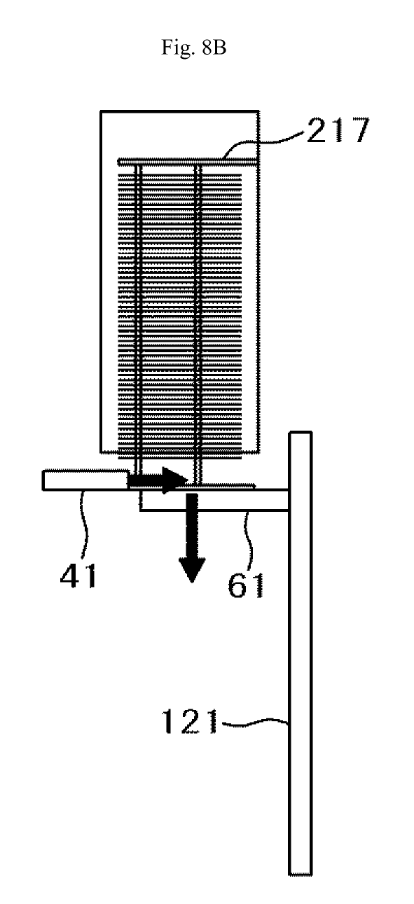

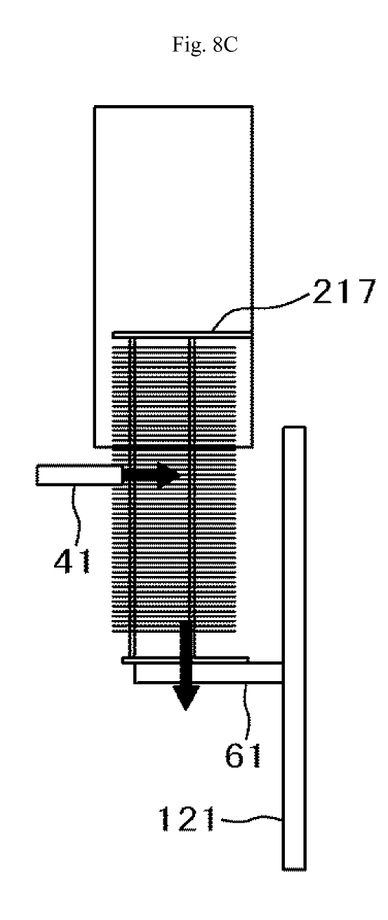

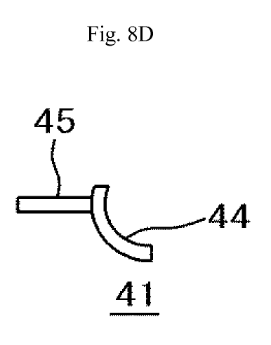

Next, a modified example of a case in which cooling gas is exhausted from the seal support arm 41 will be described with reference to FIG. 8. FIG. 8 is a view for explaining a modified example of the case in which cooling gas is exhausted from the seal support arm 41 according to the embodiment of the present invention. FIG. 8A and FIG. 8B illustrate states when the boat down starts, i.e., when the unloading of the boat 217 from the process chamber 201 starts, respectively. FIG. 8A is a plan view of the substrate processing apparatus 10 when viewed from an upper side, and FIG. 8B is a view when viewed from a side. FIG. 8C illustrates a state during the boat down, i.e., during the unloading of the boat 217 from the process chamber 201. FIG. 8D is a plan view of the seal support arm 41 used in the modified example when viewed from an upper side. In addition, FIG. 8 is a schematic view, and the seal cap 219, the seal cap base 62, and the furnace port shutter base 66 are omitted.

As shown in FIG. 8D, the seal support arm used in the modified example has a shape, which interferes with the boat 217 when the boat is down. In this case, the seal support part having an arc shape has an arc shape of about quarter of the entire circumference. Also, one end of the arc-shaped part of the seal support part 44 is installed on a front end of a rod-shaped part 45, and the seal support part 44 is distributedly installed at a side of the furnace port shutter. By such a configuration, the seal support arm 41 does not interfere with the boat 217 when the boat 217 is down.

Within the seal support arm 41, a flow path through which cooling gas, e.g., nitrogen gas is carried is installed. The flow path is connected to a nitrogen gas supply source with an MFC or valve being disposed therebetween. At the seal support part 44, a gas exhausting hole for exhausting the nitrogen gas is installed in plurality, and the nitrogen gas is exhausted from the gas exhausting holes toward the boat 217, as shown by an arrow of FIG. 8.

When the boat 217 is down, first, from the sealing state shown in FIG. 5B, the seal support arm 41 is rotated to the standby position, and then, the boat down starts. After the boat down starts, as shown in FIG. 8B, when the seal cap 219 is disposed as a position lower than that of the seal support arm 41, as shown in FIG. 8A, the seal support arm 41 is rotated to the sealing position. Then, the nitrogen gas is exhausted from the gas exhausting holes of the seal support part 44 to cool the substrate placed on the boat 217. As shown in FIG. 8C, during the boat down, the nitrogen gas is exhausted from the gas exhausting holes of the seal support part 44.

After the boat down is completed, the seal support arm 41 is rotated to the standby position shown in FIG. 5C. Then, when the furnace port shutter 116 is closed, the seal support arm 41 is rotated to the sealing position to perform the seal support operation.

In the above-described embodiment, the problems such as the generation of the particles due to the friction, the weighted furnace port shutter, and the expose of the closing assistance device to a high temperature, like the closing assistance device of the patent document 1, are reduced.

Also, the present invention is not limited to the above-described embodiment, but various changes and modifications may be made in the present invention without departing from the scope of the invention.

Also, in the embodiment, although an explanation has been given on the case of using the vertical batch type heat treatment apparatus, the present invention can also be applied to a horizontal batch type heat treatment apparatus.

Also, in the embodiment, although an explanation has been given on the case where the heat treating is performed on the wafer, an object to be treated can be a photomask or a printed wiring board, a liquid crystal panel, a compact disk, and a magnetic disk.

According to the constitutions, when the substrate is placed inside the process chamber and when the substrate is placed outside the process chamber, the process chamber can be sufficiently sealed.

(Supplementary Note) The present invention also includes the following embodiments.

(Supplementary Note 1) According to an embodiment of the present invention, there is provided a substrate processing apparatus comprising:

a process chamber comprising an opening for loading a substrate therethrough, the process chamber performing a processing operation on the substrate loaded therein;

a first cover configured to close the opening of the process chamber when a substrate is loaded in the process chamber;

a first opening/closing mechanism configured to open/close the first cover;

a second cover configured to close the opening of the process chamber when no substrate is loaded in the process chamber;

a second opening/closing mechanism configured to open/close the second cover;

a first closing assistance mechanism configured to assist a closing force of the first opening/closing mechanism; and

a first closing assistance mechanism configured to assist a closing force of the first opening/closing mechanism; and

a second closing assistance mechanism configured to assist a closing force of the second opening/closing mechanism.

If the substrate processing apparatus is configured as described above, the process chamber can be sufficiently sealed when a substrate is placed in the process chamber and when no substrate is placed in the process chamber.

(Supplementary Note 2) In the substrate processing apparatus of Supplementary Note 1, the first closing assistance mechanism and the second closing assistance mechanism may be the same closing assistance mechanism.

If the substrate processing apparatus is configured as described above, since the first closing assistance mechanism and the second closing assistance mechanism are communized, the size of the substrate processing apparatus can be reduced, and thus costs can be reduced.

(Supplementary Note 3) In the substrate processing apparatus of Supplementary Note 2, the closing assistance mechanism may rotate horizontally and reciprocate vertically.

If the substrate processing apparatus is configured as described above, the closing assistance mechanism can be easily manufactured.

(Supplementary Note 4) In the substrate processing apparatus of Supplementary Note 3, the closing assistance mechanism may rotate between a standby position and an assisting operation position. In case of closing the process chamber, the closing assistance mechanism may rotate and then ascend from the standby position to the assisting operation position to perform a closing assistance operation, and in case of opening the process chamber, the closing assistance mechanism may descend and then rotate to return to the standby position.

If the substrate processing apparatus is configured as described above, the closing assistance mechanism may be easily manufactured.

(Supplementary Note 5) In the substrate processing apparatus of Supplementary Note 1, the first opening/closing mechanism configured to open/close the first cover may comprise a first movable member extending in a horizontal direction, one end of the first movable member may be installed on the first cover, and the other end of the first movable member may be installed on a first vertical movement mechanism,

wherein the second opening/closing mechanism configured to open/close the first cover may comprise a second movable member extending in a horizontal direction, one end of the second movable member may be installed on the second cover, and the other end of the second movable member may be installed on a second vertical movement mechanism.

If the substrate processing apparatus is configured as described above, bending of the first movable member and the second movable member may be compensated for by the first closing assistance mechanism and the second closing assistance mechanism, respectively.

(Supplementary Note 6) In the substrate processing apparatus of Supplementary Note 2, the closing assistance mechanism may comprise a vertical movement mechanism, and by an ascending operation of the vertical movement mechanism, closing forces of the first opening/closing mechanism and the second opening/closing mechanism may be assisted.

(Supplementary Note 7) In the substrate processing apparatus of Supplementary Note 2, the closing assistance mechanism may comprise a pressing unit configured to apply an upward force to the first cover and the second cover, and the pressing unit may ascend up to an approximate height of the first cover or an approximate height of the second cover and apply an upward force to approximately the first cover or the second cover.

(Supplementary Note 8) In the substrate processing apparatus of Supplementary Note 2, the closing assistance mechanism may push up the first cover and the second cover from a lower side.

(Supplementary Note 9) In the substrate processing apparatus of Supplementary Note 6, the closing assistance mechanism may comprise a horizontal rotary mechanism configured to rotate in a horizontal direction.

What is claimed is:

1. A substrate processing apparatus comprising:
a process chamber comprising an opening for loading a substrate therethrough, the process chamber performing a processing operation on the substrate loaded therein;
a first cover configured to close the opening of the process chamber when a substrate is loaded in the process chamber;
a first opening/closing mechanism configured to open/close the first cover;
a second cover configured to close the opening of the process chamber when no substrate is loaded in the process chamber;
a second opening/closing mechanism configured to open/close the second cover; and
a closing assistance mechanism configured to assist the first and the second opening/closing mechanisms.

2. The substrate processing apparatus of claim 1, wherein the closing assistance mechanism comprises a vertical movement mechanism, and a closing force of each of the first and second opening/closing mechanisms is assisted by an ascending operation of the vertical movement mechanism.

3. The substrate processing apparatus of claim 1, wherein the closing assistance mechanism comprises a pressing unit configured to apply an upward force to the first cover and the second cover, and the pressing unit elevates to an approximate height of the first cover or an approximate height of the second cover and applies the upward force to approximately the first cover or the second cover.

4. The substrate processing apparatus of claim 1, wherein the closing assistance mechanism pushes up the first cover and the second cover from a lower side.

5. The substrate processing apparatus of claim 2, wherein the closing assistance mechanism comprises a horizontal rotary mechanism configured to rotate in a horizontal direction.
